(19) United States
(12) Patent Application Publication
(10) Pub. No.: US 2016/0101778 A1
(43) Pub. Date: Apr. 14, 2016

(54) method and device for operating a vehicle

(71) Applicant: ROBERT BOSCH GMBH, Stuttgart (DE)

(72) Inventors: Carsten HASBERG, Ilsfeld-Auenstein (DE); Stefan Nordbruch, Kornwestheim (DE); Oliver Pink, Stuttgart (DE)

(21) Appl. No.: 14/890,398

(22) PCT Filed: Mar. 18, 2014
(86) PCT No.: PCT/EP2014/055374

§ 371 Date: Nov. 10, 2015

(30) Foreign Application Priority Data
May 13, 2013 (DE) 10 2013 208 758.6

(51) Int. Cl. B60W 30/09; G01C 21/26

(52) U.S. Cl. CPC B60W 30/09; G01C 21/26; B60W 2550/308

(57) ABSTRACT

A method for operating a vehicle, a risk parameter being ascertained for a driving route section of a driving route of the vehicle, the risk parameter including an accident probability of the vehicle for the driving route section, the vehicle being controlled at least in an assisted manner as a function of the risk parameter, to reduce the accident probability for the driving route section. Also described is a device for operating a vehicle and a corresponding computer readable medium having a computer program.

### FIELD OF THE INVENTION

The present invention relates to a method and a device for operating a vehicle. The present invention also relates to a computer program.

### BACKGROUND INFORMATION

Driver assistance systems as such are believed to be understood. In general, such driver assistance systems, when making behavioral decisions, do not take into account whether the present driving situation poses a particular risk. An ACC system, for example, maintains a constant distance to the preceding vehicle, regardless of potential risks, for example, the probability of vehicles cutting in. The abbreviation “ACC” in this case stands for the English term “adaptive cruise control,” which is normally translated in German as adaptive speed control device.

### SUMMARY OF THE INVENTION

An object underlying the present invention may therefore be considered to be that of providing an improved method and an improved device for operating a vehicle, which overcome the aforementioned disadvantages.

The object underlying the present invention may also be considered to be that of providing a corresponding computer program.

These objects are achieved with the aid of the respective subject matter of the descriptions herein. Advantageous embodiments are the subject matter of the respective further descriptions herein.

According to one aspect, a method for operating a vehicle is provided, in which a risk parameter is ascertained for a driving route section of a driving route of the vehicle, the risk parameter including an accident probability of the vehicle for the driving route section, the vehicle being controlled at least in an assisted manner as a function of the risk parameter in order to reduce the accident probability for the driving route section.

According to another aspect, a device is provided for operating a vehicle, the device including an ascertainer for ascertaining a risk parameter for a driving route section of a driving route of the vehicle, the risk parameter including an accident probability of the vehicle for the driving route section, and the device including a control for controlling the vehicle at least in an assisted manner as a function of the risk parameter, in order to reduce the accident probability for the driving route section.

According to still another aspect, a computer program is provided, which includes program code for carrying out the method for operating a vehicle, when the computer program is run on a computer, in particular in a control system.

Thus, the present invention includes, in particular, the concept of subjecting a particular driving situation in the form of a driving route section to be driven to a risk assessment. This means in particular, therefore, that it is assessed how probable it is that the vehicle will have an accident on the driving route section while driving on this section. As a function of this probability, appropriate counteractive measures may then be taken, in particular, an at least assisted control of the vehicle, in order to reduce the accident probability.

Taking into account the accident probability and the corresponding controlling as a function of the accident probability have the particularly advantageous effect that vehicle safety may be increased. This is because it is possible to focus on the individual driving route section to be driven in terms of an adapted, at least assisted control of the vehicle. Thus, the at least assisted control of the vehicle is advantageously specifically adapted to the driving route section to be driven. Hence, the control system takes into account whether or not the risk of an accident on the driving route section to be driven is increased. Thus, for example, a speed and/or a distance to an immediately preceding vehicle may be reduced, even though, for example, a set speed predefined by the driver is greater. However, such a set speed predefined by the driver is normally predefined with no awareness of possible hazards or risks for a specific driving route section. Based on the consideration given to such risks or such hazards, a predefined greater set speed is then particularly advantageously ignored and a lower speed adapted according to the situation is selected as the new set speed, in response to which the actual vehicle speed is regulated. The aforementioned statements apply analogously to a distance to an immediately preceding vehicle.

According to one specific embodiment, the at least assisted control may include a control of a vehicle speed and/or a control of a braking system of the vehicle and/or a control of a signaling system of the vehicle and/or a control of a clutch system of the vehicle and/or a control of a steering system of the vehicle and/or a control of a drive system of the vehicle.

The wording “at least assisting control” includes, in particular, the case of an assisted control. In the case of an assisted control, the driver must generally still independently control at least one vehicle system. This means, in particular, therefore, that the driver must independently control at least a partial aspect of a vehicle longitudinal guidance and/or a vehicle transverse guidance. The driver is assisted merely in a partial aspect of the vehicle guidance. Thus, it may be provided, for example, that a vehicle longitudinal guidance or a vehicle transverse guidance is controlled with the aid of the control systems.

The wording “at least assisting control” further includes, in particular, the case of an automated control. In the case of an automated control, the vehicle is controlled independently by the control system with no intervention on the part of the driver. Thus, the automated control independently controls the vehicle longitudinal guidance and the vehicle transverse guidance, without the driver having to intervene for such purpose.

The wording “at least assisting” includes, therefore, in particular, the case of an automated control. Statements made in conjunction with an assisted control apply analogously to statements with an automated control and vice versa. This means, in particular, therefore, that the control system may be configured to control the vehicle in an automated manner as a function of the risk parameter. This means, in particular, therefore, that the vehicle may be controlled automatically as a function of the risk parameter.

According to one specific embodiment, it may be provided that an additional safety distance is added to a predetermined safety distance of a distance control device, which is configured for regulating a distance between the vehicle and an immediately preceding vehicle.

Such a distance control device may also be referred to, in particular, as an adaptive speed control device. Such a control device is normally referred to in English as “adaptive cruise control (ACC).” In contrast to known ACC control devices, which always maintain a constant distance to the preceding vehicle independently of an accident probability for a particular driving route section, the provision of an additional safety distance as a function of the risk parameter results in the regulation of a greater distance to the immediately preceding vehicle. By providing a greater safety distance, it is possible to advantageously increase a time in which the driver must react in order to avoid an accident or to reduce the severity of an accident. In particular, the driver has more time in which to adequately respond to possible hazard sources.

According to one specific embodiment, it may be provided that such a distance control device is provided. This means in particular, therefore, that the device for operating a vehicle may include such a regulating device. In particular, it may be provided that the control system is configured for regulating a distance between the vehicle and an immediately preceding vehicle. This means in particular, therefore, that the control system may include both the device for operating a vehicle and the distance control device.

According to one specific embodiment, it may be provided that when the driving route includes multiple traffic lanes, ascertaining the risk parameter includes ascertaining a respective traffic lane risk parameter for at least some of the multiple traffic lanes, which may be for all traffic lanes, the respective traffic lane risk parameter including an accident probability of the vehicle for the respective traffic lane. This means, in particular, therefore, that the risk parameter includes the respective traffic lane parameters. This means, in particular, therefore, that the ascertainer is accordingly configured for ascertaining traffic lane risk parameters.

This means, in particular, therefore, that for the individual traffic lanes, it is separately ascertained how high an accident probability for the vehicle is if it were to travel on the traffic lane in question. Thus, it may be advantageously ascertained with particular precision and sensitivity for the driving route section, in which areas of the driving route section a particularly high or a particularly low accident probability exists. It is then possible, with equal sensitivity and precision, to control the vehicle at least in an assisted, in particular automated, manner. In this way, it is possible to advantageously increase vehicle safety still further.

According to one specific embodiment, it may be provided that a corresponding or respective traffic lane risk parameter may be ascertained for all traffic lanes.

According to another specific embodiment, it may be provided that, when the traffic lane risk parameter of the traffic lane in which the vehicle is presently driving is greater than the traffic lane risk parameter of an adjacent traffic lane, the control of the vehicle includes a traffic lane change from the present traffic lane to the adjacent traffic lane. This means, in particular, therefore, that a traffic lane change is carried out in an assisted, in particular automated, manner, when it is determined that an accident probability for the present traffic lane is greater than for an adjacent traffic lane. In this way, an accident probability for the vehicle is advantageously reduced. Alternatively, it may be provided, for example, that a traffic lane change is recommended to the driver, the traffic lane change being carried out only after positive confirmation by the driver. Absent or lacking the positive confirmation or, in the case of a rejection, no traffic lane change is carried out.

An adjacent traffic lane may include a traffic lane, for example, which is situated immediately adjacent to the present traffic lane. An adjacent traffic lane may include, in particular, a traffic lane, which is indirectly adjacent to the present traffic lane. Indirectly adjacent means, in particular, that one or multiple additional traffic lanes may be situated between this traffic lane and the present traffic lane. Directly adjacent means, in particular, that an additional traffic lane is no longer situated between the immediately adjacent traffic lane and the present traffic lane.

According to one specific embodiment, it may be provided that the risk parameter is ascertained based on data selected from the following group of data: surroundings sensor data of a surroundings sensor of the vehicle for detecting the surroundings of a vehicle, map data of a digital map, traffic data, vehicle data from another vehicle, environmental data or a combination thereof.

This means, in particular, therefore, that the device may include one or multiple sensor(s), which are able to sensorily detect at least some of the aforementioned data. For example, the device may include one surroundings sensor or multiple surroundings sensors. The surroundings sensors may be, in particular, identically or differently configured. Surroundings sensors may be, for example, radar sensors, ultrasonic sensors, video sensors, Lidar sensors and/or infrared sensors.

According to one specific embodiment, it may be provided that a receiver is provided for receiving data. Such a receiver may, for example, receive vehicle data from an additional vehicle. In particular, vehicle data may also be received from multiple additional vehicles. Such vehicle data may, for example, be surroundings sensor data of these additional vehicles. The vehicle data from the additional vehicle or the additional vehicles may be, in particular, data relating to a vehicle guidance of the corresponding additional vehicle. Such data may be referred to as vehicle guidance data, for example. Such vehicle guidance data may include, for example, information about the vehicle guidance of the additional vehicle. Such vehicle guidance information thus includes, in particular, the information as to whether the additional vehicle has carried out a brake intervention and/or a steering intervention and/or a drive intervention. Thus, a strong braking action of a preceding vehicle, for example, indicates a possible hazard source. Accordingly, a speed of the vehicle, for example, may then be reduced and/or a distance to the immediately preceding vehicle may be increased.

Traffic data include, in particular, information about the traffic for the driving route section. Such information includes, in particular, traffic congestion reports and/or construction zones and/or particular topographical conditions such as, for example, a constriction on the driving route section still to be driven.

Map data of a digital map may include, in particular, direct information about whether a construction zone is located on the driving route section. Map data may include, in particular, direct information about accident black spots.

Environmental data include, in particular, information about environmental conditions for the driving route section. Such environmental conditions may be, for example, ice, snow, rain, slickness, damage to the driving route and/or obstacles on the driving route section.

According to one specific embodiment, at least some of the aforementioned data, in particular, all of the data, may be transmitted to the vehicle. The vehicle may, in particular, request or query such data from a server. Such data may, in particular, be stored or held in readiness in the cloud.

According to one specific embodiment, it may be provided that a transmitter is provided for transmitting at least some of the aforementioned data, in particular, all of the data. Thus, the vehicle itself may advantageously also send corresponding information to additional vehicles or to a server, in particular to the cloud.

According to one specific embodiment, it may be provided that ascertaining the risk parameter includes ascertaining a vehicle density of the driving route section, in particular, of a traffic lane, in particular, of multiple traffic lanes. This ascertainment of the vehicle density may be carried out, in particular, with the aid of a surroundings sensor or multiple surroundings sensors, i.e., in particular, based on the corresponding surroundings sensor data of the surroundings sensors. The ascertainment of the vehicle density may be carried out, in particular, based on the aforementioned data.

Thus, it is normally more dangerous to travel in a traffic lane which has an increased vehicle density. Generally, it is then meaningful to change traffic lanes or to reduce the speed and/or a distance to an immediately preceding vehicle. By ascertaining the vehicle density, it is then possible to take these appropriate measures, which may advantageously increase vehicle safety.

In particular, when a vehicle density for an adjacent traffic lane is increased as compared to the present traffic lane, it is then generally meaningful to change to a different traffic lane away from this traffic lane having the increased vehicle density, in order to obtain a greater distance between the vehicle and this traffic lane having the increased vehicle density. This is because, in general, vehicles change from one traffic lane having an increased vehicle density to another traffic lane adjacent to this traffic lane having the increased vehicle density in order, for example, to be able to move ahead more quickly. A cutting-in of such vehicles into the present traffic lane creates an increased accident risk, however. This accident risk may then be advantageously reduced when, for example, a lane change is made and/or a vehicle speed is reduced and/or a distance to an immediately preceding vehicle is reduced.

Potential information sources for a risk assessment of the driving route section, i.e., in particular, for ascertaining the risk parameter, may be surroundings sensors of the vehicle, for example. For example, video sensors may be provided, which sensorily detect the vehicle surroundings. Due to a corresponding evaluation of the surroundings sensor data, it is possible, for example, to ascertain a vehicle density for individual traffic lanes. For example, it is possible to determine with the aid of a surroundings sensor which topographical structure the driving route section includes. Such a topographical structure may be, for example, a highway interchange, a highway on-ramp or a constriction. The aforementioned topographical structures may, for example, be detected or ascertained with the aid of map data of a digital map. Traffic data containing, in particular, corresponding information regarding a risk parameter, may be transmitted to the vehicle. It may be provided that vehicle data from one additional vehicle or multiple additional vehicles may be transmitted to the vehicle.

The statements made in conjunction with the device apply analogously to the method and vice versa. The specific embodiments corresponding to the device result in specific embodiments which correspond to the method and vice versa.

The present invention is described in greater detail below with reference to the exemplary embodiments.

The same reference numerals may be used below for the same features.

### BRIEF DESCRIPTION OF THE DRAWINGS

FIG. 1 shows a flow chart of a method for operating a vehicle.

FIG. 2 shows a device for operating a vehicle.

FIG. 3 shows a flow chart of an additional method for operating a vehicle.

FIG. 4 shows a highway interchange.

FIG. 5 shows a highway on-ramp.

FIG. 6 shows a constriction.

### DETAILED DESCRIPTION

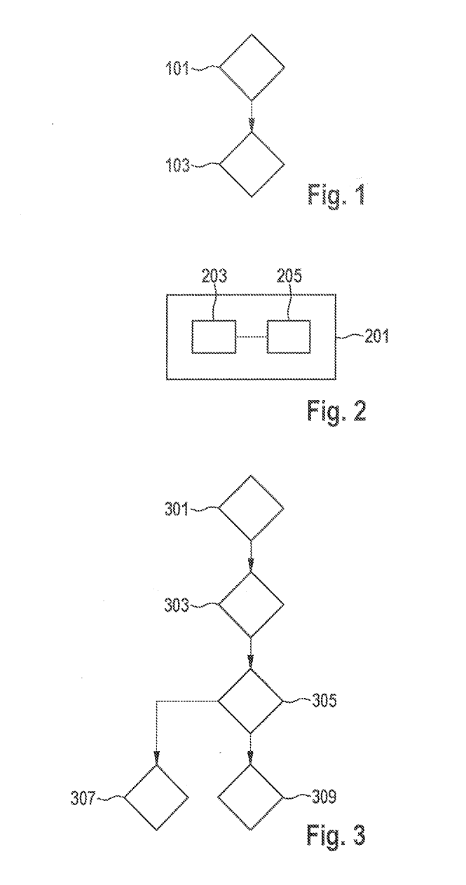

FIG. 1 shows a flow chart of a method for operating a vehicle.

According to a step 101, a risk parameter for a driving route section of a driving route of the vehicle is ascertained. The risk parameter includes an accident probability of the vehicle for the driving route section. According to a step 103, the vehicle is controlled at least in an assisted, which may be automated, manner, as a function of the ascertained risk parameter. This advantageously results in a reduction of an accident probability for the driving route section.

FIG. 2 shows a device 201 for operating a vehicle (not shown).

Device 201 includes an ascertainer 203. Ascertainer 203 is configured for ascertaining a risk parameter for a driving route section of a driving route of the vehicle. The risk parameter includes an accident probability of the vehicle for the driving route section. In addition, device 201 includes a control system 205. Control system 205 is configured for controlling the vehicle at least in an assisted, which may be automated, manner as a function of the risk parameter, in order to reduce the accident probability for the driving route section.

Since the vehicle is controlled at least in an assisted, which may be an automated manner as a function of an accident probability for the driving route section, vehicle safety is advantageously increased. In particular, in contrast to known driver assistance systems, possible risks and/or potential hazard sources, which may be found on the driving route section, are advantageously taken into account with the at least assisted control. This means, in particular, therefore, that a safety distance to an immediately preceding vehicle, for example, is increased. As a result, the driver generally has more time to react, in order to defuse a critical situation or to avoid an accident.

Possible information sources for a risk assessment of the driving route section, i.e., for ascertaining the risk parameter, in particular, may be surroundings sensors of the vehicle, for example. For example, video sensors may be provided, which sensorily detect the vehicle surroundings. Due to a corresponding evaluation of the surroundings sensor data, it is possible, for example, to ascertain a vehicle density for individual traffic lanes. For example, it is possible to determine with the aid of a surroundings sensor which topographical structure the driving route section includes. Such a topographical structure may be, for example, a highway interchange, a highway on-ramp or a constriction. The aforementioned topographical structures may, for example, be detected or ascertained with the aid of map data of a digital map. Traffic data containing, in particular, corresponding information regarding a risk parameter, may be transmitted to the vehicle. It may be provided that vehicle data from one additional vehicle or multiple additional vehicles may be sent to the vehicle.

FIG. 3 shows a flow chart of an additional method for operating a vehicle.

According to a step 301, the present topography of the driving route section is detected. Video sensors, for example, may be provided for such a purpose. Detecting according to step 301 may include, in particular, the detection that multiple traffic lanes are provided. In a step 303, a traffic lane risk parameter is then ascertained for each of the traffic lanes. This means, in particular, therefore, that it is ascertained how high an accident probability is for each of the traffic lanes, if the vehicle were to travel in the corresponding traffic lane.

In a step 305, the traffic lane risk parameter of the present traffic lane, in which the vehicle is presently traveling is then compared to the other traffic lane risk parameters of the other traffic lanes. If it is then determined in a step 305 that there are traffic lanes which have a lower accident risk than the present traffic lane, i.e., in particular, a lower traffic lane risk parameter than the traffic lane risk parameter of the present traffic lane, a traffic lane change is then carried out in a step 307, in order to reach the traffic lane having the lower traffic lane risk parameter.

If, in comparison, it is determined according to step 305 that the traffic lane risk parameter of the present traffic lane is the lowest traffic lane risk parameter, then, according to a step 309, the vehicle remains in the present traffic lane. This means in particular, therefore, that the vehicle continues to travel in the present traffic lane. No traffic lane change takes place.

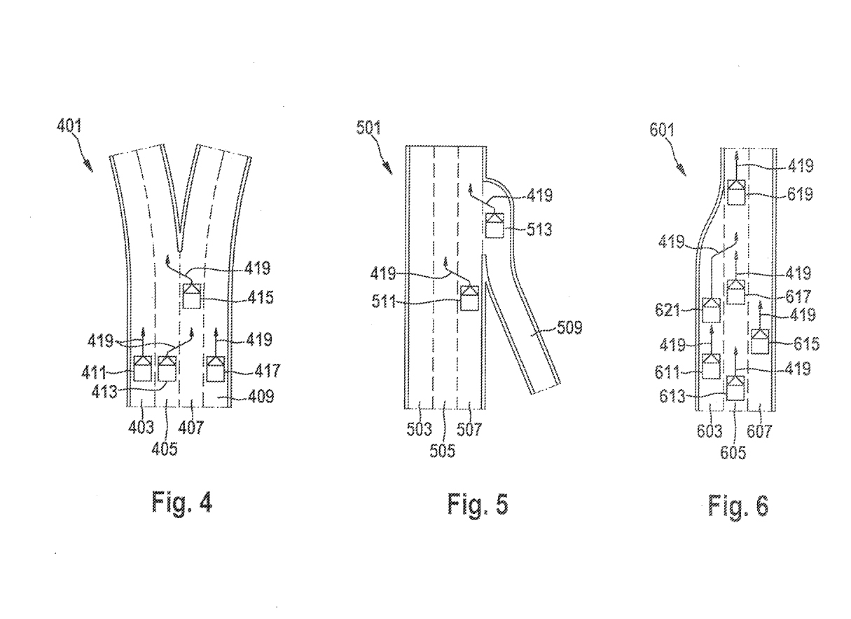

FIG. 4 shows a highway interchange 401.

Four traffic lanes 403, 405, 407 and 409 are provided. The two left traffic lanes 403 and 405 branch to the left. The two right traffic lanes 407 and 409 branch to the right.

Four vehicles 411, 413, 415 and 417 traveling in individual traffic lanes 403, 405, 407 and 409 are also shown. In this instance, vehicle 411 is traveling in far left traffic lane 403. Vehicle 413 is traveling in second to left traffic lane 405. Vehicle 415 is traveling in second to right traffic lane 407. Vehicle 417 is traveling in far right traffic lane 409.

A corresponding travel trajectory of individual vehicles 411, 413, 415 and 417 is depicted with an arrow in each case, identified by reference numeral 419.

In general, more traffic lane changes take place in the two center traffic lanes 405 and 407. This means, in particular, therefore, that in these two traffic lanes 405 and 407, there is an increased probability of a traffic lane change. This is, in particular, as compared to the two outer traffic lanes 403 and 409. This is exemplified in FIG. 4, insofar as the two vehicles 413 and 415 will carry out a traffic lane change. The two vehicles 411 and 417 are not carrying out a traffic lane change.

However, a traffic lane change of a vehicle generally poses an increased accident risk. A sudden cutting-in to the corresponding target lane or the corresponding target traffic lane may result in a critical situation. This means, in particular, therefore, that the two middle traffic lanes 405 and 407 have a high accident risk for vehicles traveling in these two traffic lanes. A risk parameter is increased accordingly. This is, in comparison, in particular, to the two outer traffic lanes 403 and 409, in which an accident risk is lower. This means, in particular, therefore, that a corresponding risk parameter for these two traffic lanes is lower than the corresponding risk parameters for the two middle traffic lanes 405 and 407.

This information is advantageously used in order to at least assist, which may be to automatically control, the vehicle. If, for example, a vehicle is traveling in traffic lane 405 and already knows that it will branch off to the left, it will then logically change to far left traffic lane 403, since this lane has a lower accident risk. The same applies, in particular, to vehicles traveling in traffic lane 407 and intending to branch off to the right.

FIG. 5 shows a highway on-ramp 501.

Three traffic lanes 403, 405 and 507 are provided. An on-ramp traffic lane 509 is also provided, via which vehicles are able to reach the three traffic lanes 503, 505 and 507.

Two vehicles 511 and 513 are plotted. Vehicle 511 is traveling in far right traffic lane 507. Vehicle 513 is traveling in on-ramp traffic lane 509, in order to change to traffic lane 507. This merging maneuver generally poses an increased accident risk. This means, in particular, therefore, that vehicles traveling in far right traffic lane 507 and, possibly, also in middle traffic lane 505, have a higher accident risk than vehicles traveling in far left traffic lane 503. This means, in particular, therefore, that traffic lane 503 has the lowest traffic lane risk parameter as compared to the traffic lane risk parameters of the two traffic lanes 505 and 507.

This information is then advantageously used by vehicle 511, in order to carry out a traffic lane change from traffic lane 507 to traffic lane 505 and, possibly, to traffic lane 503. Generally, therefore, vehicle 513 is then advantageously able to easily merge into the traffic in traffic lane 507.

FIG. 6 shows a constriction 601.

Three traffic lanes 603, 605 and 607 are provided, whereby traffic lane 603 ends and there are then only two traffic lanes 605 and 607.

Vehicles 611, 613, 615, 617, 619 and 621 are also plotted. Vehicles 611 and 621 are traveling in far left traffic lane 603. Vehicles 613, 617 and 619 are traveling in the middle lanes. Vehicle 615 is traveling in far right traffic lane 607.

Due to the constriction or reduction from three to two traffic lanes, the two vehicles 611 and 621 are forced to change from far left traffic lane 603 to middle traffic lane 605. In general, this poses an increased accident risk for vehicles 611, 621, 613, 617 and 619. This is, in particular, because a vehicle density in middle traffic lane 605 is increased as a result. The corresponding vehicle traffic may, in particular, also frequently stall.

This means, in particular, therefore, that a traffic lane risk parameter for middle traffic lane 605 is greater as compared to far right traffic lane 607 and as compared to far left traffic lane 603. Vehicles located in middle traffic lane 605 will then logically carry out a traffic lane change in the direction of far right traffic lane 607. This advantageously results in a reduction in the vehicle density in middle traffic lane 605.

Thus, the present invention includes, in particular, the concept of providing a device and a method for operating a vehicle, which advantageously enables at least an assisted, in particular, automated, in particular, a highly automated travel on driving route sections, in particular on highways. A vehicle speed, in particular, is independently adapted. A lane may be independently maintained. A traffic lane change may be independently carried out. Each traffic lane is, in particular, separately provided with a risk assessment. This means, in particular, therefore, that a respective traffic lane risk parameter is ascertained for the traffic lanes. In particular, a route is automatically planned, which has an advantageously low risk or accident risk. Thus, if necessary, a traffic lane change may be automatically carried out if traveling in the target traffic lane is less risky. This means, in particular, therefore, that the target traffic lane has a lower traffic lane risk parameter than the present traffic lane.

The following information sources may be used individually or in combination for the risk assessment, i.e., for ascertaining the traffic lane risk parameters, lane and traffic lane being used synonymously:
Information about accident black spots is retrieved from a map. In this case, all traffic lanes, for example, have an increased risk assessment. This information is provided, in particular, in the form of digital map data.
Instantaneous information on traffic congestion is retrieved via traffic news, for example, and/or from the cloud. Generally, an increased risk exists near the tail end of traffic congestion. Such information is provided, in particular, as traffic data.
Additional information about black ice, objects on the roadway, both lane-specific, for example, may be retrieved from the cloud. Such information is provided, in particular, in the form of environmental data.
In the area of highway interchanges (detection by map (digital map data) and/or by surroundings sensors (surroundings sensor data)), traffic lane changes in a middle traffic lane are generally highly probable and are high risk (cf. FIG. 4); outer lying lanes are generally low risk.
In the area of highway on-ramps (detection by map (digital map data) and/or by surroundings sensors (surroundings sensor data)), there is an increased risk in the far right lane due to incoming vehicles, in the middle lane generally also due, for example, to trucks, which change from the right to the middle lane or traffic lane (cf. FIG. 5).
In the case of constrictions from, for example, three to two traffic lanes (detection by map (digital map data) and/or by surroundings sensors (surroundings sensor data)), the traffic in the middle traffic lane is generally highly condensed and normally frequently stalls, which may cause a high risk. The far left traffic lane also carries an increased risk as a result of the required merging maneuver.

In contrast, the far right traffic lane possesses a significantly lower risk (cf. FIG. 6).

1-8. (canceled)

9. A method for operating a vehicle, the method comprising:
ascertaining a risk parameter for a driving route section of a driving route of the vehicle, the risk parameter including an accident probability of the vehicle for the driving route section; and
controlling the vehicle at least in an assisted manner as a function of the risk parameter, so as to reduce the accident probability for the driving route section.

10. The method of claim 9, wherein an additional safety distance is added as a function of the risk parameter to a predetermined safety distance of a distance control device, which is for regulating a distance between the vehicle and an immediately preceding vehicle.

11. The method of claim 9, wherein, when the driving route includes multiple traffic lanes, the ascertainment of the risk parameter includes ascertaining a respective traffic lane risk parameter for at least some of the multiple traffic lanes, the respective traffic lane risk parameter including an accident probability of the vehicle for the respective traffic lane.

12. The method of claim 11, wherein, if the traffic lane risk parameter of the traffic lane in which the vehicle is presently traveling is greater than the traffic lane risk parameter of an adjacent traffic lane, the control of the vehicle includes a traffic lane change from the present traffic lane to the adjacent traffic lane.

13. The method of claim 9, wherein the risk parameter is ascertained based on data selected from surroundings sensor data of a surroundings sensor of the vehicle for detecting the vehicle surroundings, map data of a digital map, traffic data, vehicle data from an additional vehicle, environmental data.

14. The method of claim 9, wherein the ascertainment of the risk parameter includes ascertaining a vehicle density of a traffic lane.

15. A device for operating a vehicle, comprising:
an ascertaining arrangement to ascertain a risk parameter for a driving route section of a driving route of the vehicle, the risk parameter including an accident probability of the vehicle for the driving route section; and
a control system to control the vehicle at least in an assisted manner as a function of the risk parameter, so as to reduce the accident probability for the driving route section.

16. A computer readable medium having a computer program, which is executable by a processor, comprising:
a program code arrangement having program code for operating a vehicle, by performing the following:
ascertaining a risk parameter for a driving route section of a driving route of the vehicle, the risk parameter including an accident probability of the vehicle for the driving route section; and
controlling the vehicle at least in an assisted manner as a function of the risk parameter, so as to reduce the accident probability for the driving route section.
